(19) United States
(12) Patent Application Publication
(10) Pub. No.: US 2009/0226660 A1
(43) Pub. Date: Sep. 10, 2009

(54) HEAT INSULATING BODY FOR FORMING SECTIONS FOR THERMAL BREAK DOOR AND WINDOW FRAMES

(75) Inventor: Maurizio Dampierre, Ornago (IT)

Correspondence Address: NIXON & VANDERHYE, PC, 901 NORTH GLEBE ROAD, 11TH FLOOR, ARLINGTON, VA, 22203, US

(73) Assignee: NORSK HYDRO ASA, Oslo (NO)

(21) Appl. No.: 12/244,881

(22) Filed: Oct. 3, 2008

(30) Foreign Application Priority Data
Oct. 5, 2007 (IT) MI2007001933

(51) Int. Cl. E04B 2/00; B32B 3/02; B32B 3/06

(52) U.S. Cl. 428/66.4; 428/218; 428/161; 428/83; 428/192

(57) ABSTRACT

A body of heat-insulating material designed to be assembled with two half-shells made of metallic material, so as to form a section configured to produce a thermal break door or window frame, said body of heat-insulating material comprising a first plastic material having a first degree of compressibility, characterized in that it also comprises a second material with a second degree of compressibility, wherein said second degree of compressibility is greater than said first degree of compressibility.

The present invention relates to the sector of aluminium or aluminium alloy sections for forming door and window frames or the like. In particular, it relates to a heat-insulating body for forming a section for a thermal break door or window frame.

In the present description and in the claims the term “half-shell” shall be used to indicate a longitudinally elongated body with a substantially rectilinear axis which has any cross-sectional form and which, when assembled with another corresponding half-shell and a heat-insulating body, forms a section. Each half-shell is typically made of aluminium or aluminium alloy and is typically obtained by means of extrusion. As regards the above, in the present description and in the claims the term “section” shall be used to indicate the assembly consisting of two half-shells and a heat-insulating body. The heat-insulating body is also a longitudinally elongated with any cross-sectional form. Typically, this heat-insulating body is a part obtained by means of extrusion and made of a heat-insulating material.

For some time “thermal break” sections for forming thermal break door and window frames have been known. In thermal break sections, the aluminium part exposed externally is separated from the inner part by means of heat-insulating bodies. Inside these sections a thermal break chamber with walls consisting of heat-insulating material is formed. Generally, this material is a plastic material. Typically this plastic material is a polyamide. This chamber made partially of plastic material interrupts the transmission of the heat by means of conduction between the outer part and inner part and provides the frame with a high heat-insulating power.

In the thermal break sections which are known at present the thermal break chamber is formed by inserting the end of two polyamide bars inside special seats provided in two half-shells of the section. Alternatively, heat-insulating bodies with a tubular shape are used. Engagement of the polyamide bars or the tubular body is performed in the flat condition. In other words, the fixing points are positioned on two parallel surfaces. Each of the above-mentioned special seats is delimited by a pair of deformable longitudinal teeth or a deformable longitudinal tooth and a fixed shoulder. During insertion of the bars or the tubular body, the teeth are all open so as to allow, precisely, easy insertion of the bars or the tubular body, respectively. After inserting the bars or the tubular body inside the respective seats rolling is performed. The rolling machine compresses the teeth of either seat and ensures rigid joining together of the bars, or the tubular body, made of heat-insulating material and the half-shells.

Typically, before inserting the polyamide bars into the seats, at least a part of the bottom of the seats is knurled. Knurling of the bottom is performed in order to improve the so-called “pull-out strength”, i.e. fix more firmly the polyamide bars to the section.

The Applicant has noted that this knurling of the bottom of the receiving seats constitutes a further machining operation and involves the use of a special apparatus with knurling rollers. Inconveniently, the knurling apparatus must be adapted to the shape and form of the sections.

An even greater problem, which is associated with knurling of the bottom of the seats and has been identified by the Applicant, consists in the fact that this knurling operation requires time and hinders production-line assembly of the section.

Moreover, inconveniently, knurling of the bottom of the seats prevents sliding of the bars (or tubular body) inside the said seats. This constitutes a serious problem limiting productivity.

The Applicant aims to provide a section which can be assembled on a production line ensuring greater productivity, but which, at the same time, has high pull-out strength properties. The fact of being able to assemble a thermal break section on a production line constitutes a significant advantage and results in major advantages from a cost point of view. In fact, being able to dispense with performing a machining operation avoids the associated costs of the machining apparatus (knurling rollers) and reduces the machining times.

The above objects, together with others, are obtained owing to the fact that at least one second snug is provided on the tooth which locks the heat-insulating body. When the tooth is bent to lock the heat-insulating body, this second snug engages with the heat-insulating body and looks it firmly. According to the invention, the second snug engages with the heat-insulating body along a portion thereof which has a density less than that of the remainder of the heat-insulating body. This portion, which has, precisely, a density less than that of the remainder of the heat-insulating body, is compressed by the second snug and stably locks the heat-insulating body, preventing it from sliding.

According to a first aspect, the present invention provides a heat-insulating body designed to be assembled with two half-shells made of metallic material, so as to form a section configured to produce a thermal break door or window frame, said body of heat-insulating material comprising a first plastic material having a first degree of compressibility, characterized in that it also comprises a second material with a second degree of compressibility, wherein said second degree of compressibility is greater than said first degree of compressibility.

“Degree of compressibility” in the present description and in the claims is understood as meaning the capacity of a body, made of a certain material, to be compressed. A low degree of compressibility indicates that the material is substantially rigid and may be penetrated with difficulty. A greater degree of compressibility indicates that the material may be penetrated more easily than a material with a smaller degree of compressibility.

The first material is preferably chosen from the group composed of: polyamide, PVC, ABS or Tefanyl.

The first material is preferably chosen from the group composed of: a substantially flexible PVC, a rubber, a glue, a mastic or a resin.

The second material has preferably a density less than that of the first material.

In one embodiment, the second material is in the form of a cord with any cross-sectional form which is inset at least partially inside a special cavity formed in the body of heat-insulating material.

The cord may be obtained by means of coextrusion with the remainder of the body of heat-insulating material.

In one embodiment, the cord may comprise a glue which can be activated when exposed to a certain mechanical pressure and/or to a certain temperature.

The cord may have a form, viewed in cross-section, which is approximately circular, with a diameter ranging generally between about 1.0 mm and 1.5 mm.

The cord may have an open form, viewed in cross-section, for example an Ω, C or I shaped form, or a closed form.

In one embodiment, the body of heat-insulating material comprises two end heads and the second material with a second degree of compressibility is arranged in the region of said heads.

A detailed description of the invention is now provided purely by way of a non-limiting example, to be read with reference to the accompanying sets of drawings, in which:

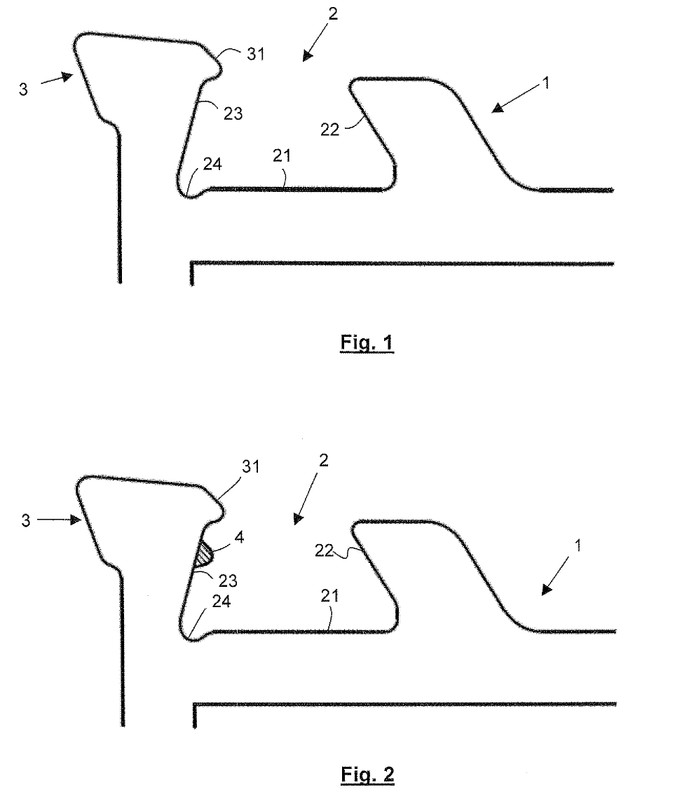

FIG. 1 is an enlarged cross-sectional view of a portion of a known half-shell for forming a section for a thermal break door or window frame;

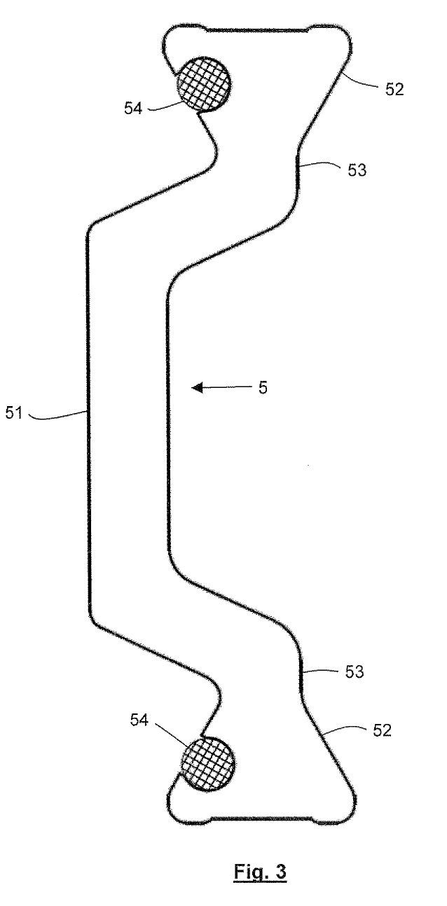

FIG. 2 is an enlarged cross-sectional view of a portion of a half-shell which can be used with a heat-insulating body according to an embodiment of the present invention;

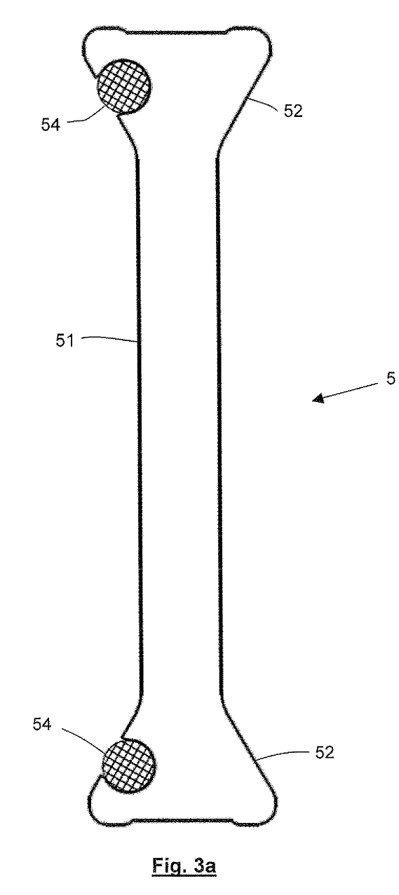

FIG. 3 is an enlarged cross-sectional view of a bar of heat-insulating material according to an embodiment of the invention;

FIG. 3a is an enlarged cross-sectional view of a bar of heat-insulating material according to another embodiment of the invention; and

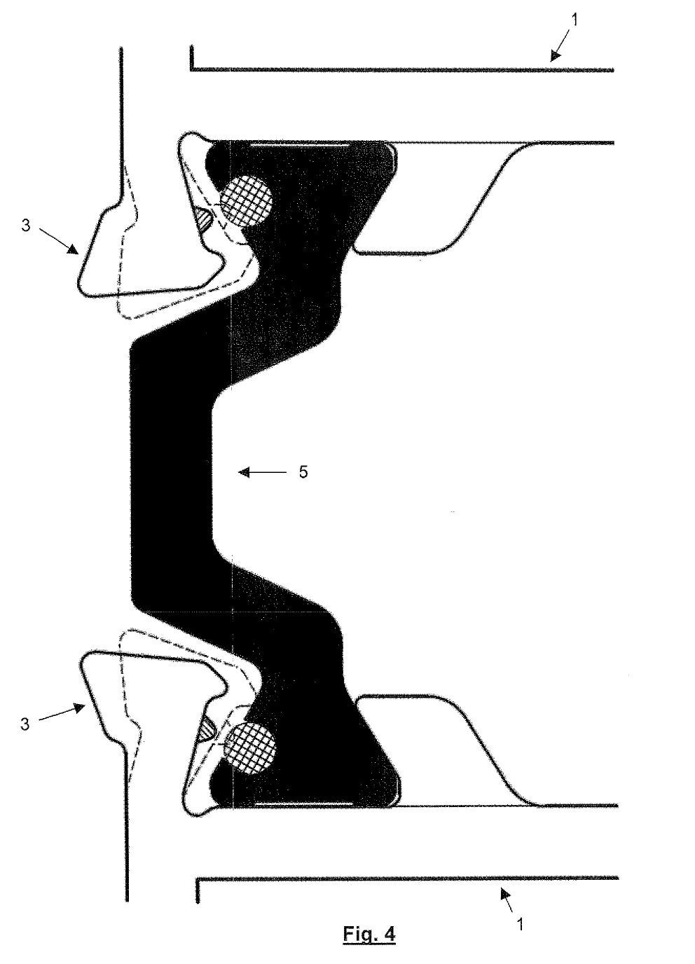

FIG. 4 is an enlarged cross-sectional view of a portion of an assembled section with a heat-insulating body according to an embodiment of the invention.

With reference initially to FIG. 1, this shows an enlarged cross-sectional view of a portion of a known half-shell 1 for forming a section for a thermal break door or window frame. In particular, it shows an enlarged view of a seat 2 designed to receive the end of a heat-insulating body (not shown in FIG. 1). The seat 2 defines a roughly trapezoidal space and is delimited by a bottom surface 21 and by two sides 22, 23. The first side 22 is a fixed shoulder, while the second side 23 is formed by a deformable tooth 3. In other embodiments (not shown), the shoulder is replaced by another deformable tooth and therefore the seat 2 is delimited by two deformable teeth 3. Typically, a groove 24 is provided in the zone where the bottom 21 of the seat 2 joins the deformable tooth 3. The deformable tooth 3 of the seat 2 which receives the heat-insulating body terminates in a snug 31 which extends towards the inside of the seat 2.

In order to assemble a section 1 and a heat-insulating body (not shown in FIG. 1) inserted partially inside its seat, the locking tooth 3 is rotated so that the projecting snug 31 moves towards the bottom 21 of the seat 2. Obviously, in the case where the seat 2 is delimited by two teeth 3, both are rotated towards the bottom 21. In this way the heat-insulating body is prevented from coming out of its seat and sliding of the heat-insulating body with respect to the section 1 is limited. In the known sections, typically, part of the bottom 21 of the seat 2 is knurled so as to further improve the pull-out strength.

FIG. 2 shows a cross-sectional view of a portion of a half-shell 1 designed to mate with a body of heat-insulating material according to a second embodiment of the present invention so as to form a section of a thermal break door or window frame. In particular it shows an enlarged view of a seat 2 designed to receive the end of a heat-insulating body (not shown in FIG. 2). The seat 2 defines a roughly trapezoidal space and is delimited by a bottom surface 21 and by two sides 22, 23. The first side 22 is a fixed shoulder, while the second side 23 is formed by a deformable tooth 3. In other embodiments (not shown), the shoulder is replaced by another deformable tooth 3 and therefore the seat 2 is delimited by two deformable teeth 3. Typically, a groove 24 is provided in the zone where the bottom 21 of the seat 2 joins the deformable tooth 3. The deformable tooth 3 of the seat 2 which receives the heat-insulating body terminates in a first snug 31 which extends towards the inside of the seat 2. According to the present invention, in addition to the first snug, at least one second snug 4 designed to penetrate into the heat-insulating body is provided, as will be explained more fully below.

Preferably, the second snug 4 is provided in a lower position than the first snug 31, in the side of the tooth 3 which delimits the seat 2. In other words, said second snug 4 is provided between the groove 24 and the first snug 31.

Obviously, the second snug 4 may have any cross-sectional form, i.e. for example that of an isosceles triangle with a rounded vertex. It could, however, have a form with a sharp corner and a square, pentagonal, hexagonal or similar cross-section.

FIG. 3 shows a cross-section of a constructional form of a heat-insulating body 5 designed to form a section according to an embodiment of the present invention. Viewed in cross-section, the heat-insulating body 5 comprises an elongated central part 51, two approximately trapezoidal heads 52 and two sections 53 which connect the heads 52 to the ends of the central part 51. The central part 51 and the two connecting sections 53 form roughly an Ω (omega) shape. The two approximately trapezoidal heads 52 are configured so as to engage inside the seats 2. In an alternative, shown in FIG. 3a, the body of heat-insulating material has a substantially straight, I-shaped, cross-sectional form. In any case, for the purposes of the present invention, the body of heat-insulating material could have any open or closed (tubular) cross-sectional form.

The body of heat-insulating material 5 may be made of polyamide, PVC, ABS or other plastic which is substantially rigid and cannot be easily compressed. The Applicant has established that an advantageous material in terms of weight and (low) thermal conductivity is Tefanyl. According to a preferred embodiment of the present invention, the heat-insulating body 5 comprises a portion 54 thereof made of soft material. This portion 54 of softer material may be in the form of a cord with a roughly circular cross-sectional form suitable for housing inside a special cavity formed in the body of heat-insulating material 5. Generally, for the purposes of the present invention, “softer material” is understood as meaning a material suitable for being compressed more easily than the remainder of the heat-insulating body. Typically, this material has a density less than that of the remainder of the heat-insulating body 5. In one embodiment, the cross-section of the cavity which receives the cord 54 is substantially circular with a diameter of between about 1.0 mm and 1.5 mm. In a preferred embodiment, the diameter of the cavity is equal to about 1.2 mm. Preferably, the cord is obtained by means of co-extrusion.

This cord may consist of glue or the like which can be activated when exposed to a certain pressure and/or to a certain temperature.

According to a first embodiment, the portion 54 of softer material projects slightly from the profile of the body of heat-insulating material 5. The amount of this projection may be in the region of 0.1 mm to 0.2 mm and preferably is equal to about 0.15 mm. In a possible variant, the portion 54 of softer material is substantially flush with the profile of the body of heat-insulating material 5. In a further embodiment, the portion 54 of softer material is inset with respect to the profile of the body of heat-insulating material 5.

The number and position of the portions 54 of softer material depends on the number of second snugs 4 and their position. In one embodiment (that shown in FIG. 3) two portions 54 of softer material are provided since each receiving seat 2 is formed by a fixed shoulder and by a deformable tooth 3 and only the latter is provided with a second snug 4. In other embodiments (not shown), for each head 52, two portions 54 of softer material, one on each opposite side of each head, may be provided. In other embodiment (not shown), for each side of each head 52, two (or more) portions 54 of softer material may be provided.

The portions 54 of softer material may be made with a substantially flexible PVC, a rubber, an adhesive, a mastic or similar material. A material which is considered particular suitable for the purpose is resin from the family NORYL® available, for example, from GE plastics, which has its head office in Pittsfield, Mass., United States of America, a division of General Electric. For example, the resin NORYL PPX7110 (unreinforced), the resin NORYL PPX7112 (paintable/unreinforced), the resin NORYL PPX7115 (unreinforced), the resin NORYL PPX630 (30% reinforced) or the resin NORYL PPX640 (40% reinforced) may be used. Advantageously these resins have a better transmittance than polyamide or a similar material.

FIG. 4 shows an enlarged cross-section of a portion of a section according to an embodiment of the invention, comprising a heat-insulating body 5 and two half-shells 1. In particular assembly of the heat-insulating body 5 on the half-shells 1 is shown: inside each seat 2 the tooth passes from its initial position (where it allows the head 52 of the body 5 of heat-insulating material to be inserted inside the respective seat 2), into its locking position (indicated by broken lines). As can be noted, in the locking position, the second snug 4 of each tooth 3 has penetrated into the respective portion 54 of softer material, firmly fixing the body 5 of heat-insulating material to the section. Penetration of the second snug occurs, advantageously, in succession after penetration of the first snug.

The Applicant has measured the pull-out strength—in accordance with that stipulated by the standard UNI ENI 14024 category W—of the half-shells 1 when assembled with the body of heat-insulating material according to the embodiment of FIG. 4. According to this standard, the minimum pull-out value must be 24 Newton per mm. The Applicant has measured a pull-out strength value of about 400 to 500 kg on a 10 cm sample, i.e. far greater than that stipulated by the above-mentioned standard.

In an alternative embodiment, the body of heat-insulating material is formed by co-extruding a first material which has a first density with a second material which has a second density less than the first density.

Advantageously, according to the invention, machining of the half-shells with knurling of the bottom of the seat is avoided. The section, together with the second snug (or with more than one second snug), is obtained by means of drawing and the assembly process may be performed continuously on a production line. This results in a considerable reduction in costs and machining time.

As a result of the present invention it is possible to perform on a production line assembly with a productivity substantially twice that of the productivity for assembly of the half-shells where the bottom of the seats is knurled.

The two half-shells may be obtained by means of extrusion separately and independently of one another or may be obtained by means of a single die with subsequent cutting of a bridge-piece joining them together.

1. Body of heat-insulating material designed to be assembled with two half-shells made of metallic material, so as to form a section configured to produce a thermal break door or window frame, said body of heat-insulating material comprising a first plastic material having a first degree of compressibility, characterized in that it also comprises a second material with a second degree of compressibility, wherein said second degree of compressibility is greater than said first degree of compressibility.

2. Body of heat-insulating material according to claim 1, characterized in that said first material is preferably chosen from the group composed of: polyamide, PVC, ABS or Tefanyl.

3. Body of heat-insulating material according to claim 1, characterized in that said first material is chosen from the group composed of: a substantially flexible PVC, a rubber, an adhesive, a mastic or a resin.

4. Body of heat-insulating material according to claim 1, characterized in that said second material has a density less than that of the first material.

5. Body of heat-insulating material according to claim 1, characterized in that said second material is in the form of a cord with any cross-sectional form inset at least partially inside a special cavity formed in the body of heat-insulating material.

6. Body of heat-insulating material according to claim 5, characterized in that the cord is obtained by means of coextrusion with the remainder of the body of heat-insulating material.

7. Body of heat-insulating material according to claim 5, characterized in that said cord comprises a glue which can be activated when exposed to a certain mechanical pressure and/or to a certain temperature.

8. Body of heat-insulating material according to claim 5, characterized in that said cord has a form, viewed in cross-section, which is approximately circular, with a diameter preferably between about 1.0 mm and 1.5 mm.

9. Body of heat-insulating material according to claim 1, characterized in that it has an open form, viewed in cross-section, for example an Ω, C or I shaped form, or a closed form.

10. Body of heat-insulating material according to any claim 1, characterized in that it comprises two end heads and in that said second material with a second degree of compressibility is arranged in the region of said heads.
